(19) United States
(12) Patent Application Publication
(10) Pub. No.: US 2025/0266463 A1
(43) Pub. Date: Aug. 21, 2025

(54) COMPOSITE CARBONACEOUS CONDUCTIVE MATERIALS AND NON-AQUEOUS ELECTROLYTE RECHARGEABLE BATTERIES

(71) Applicant: Samsung SDI Co., Ltd., Yongin-si (KR)

(72) Inventors: Jinseok BAEK, Yongin-si (KR); Hiroshi KIMURA, Yongin-si (KR); Takayoshi FUJITA, Yongin-si (KR); Koji HOSHIBA, Yongin-si (KR); Suguru NODA, Yongin-si (KR); Takazumi KAIDA, Yongin-si (KR); Sota EBISU, Yongin-si (KR)

(21) Appl. No.: 19/053,327

(22) Filed: Feb. 13, 2025

(30) Foreign Application Priority Data
Feb. 16, 2024 (JP) 2024-022335
Feb. 7, 2025 (KR) 10-2025-0016224

(51) Int. Cl. H01M 4/62; C01B 32/168; H01M 4/02; H01M 4/13; H01M 4/36

(52) U.S. Cl. CPC H01M 4/628; C01B 32/168; H01M 4/13; H01M 4/366; H01M 4/625; C01B 2202/06; C01P 2004/80; C01P 2006/40; H01M 2004/021; H01M 2004/028

(57) ABSTRACT

A composite carbonaceous conductive material including a carbon nanotube, and a coating layer on a surface of the carbon nanotube, and the coating layer including a nitrogen element (N), a boron element (B), and an oxygen element (O) is provided. A weight ratio (B/N ratio) of a content (e.g., amount) of the boron element (B) to a content (e.g., amount) of the nitrogen element (N) in the coating layer is greater than or equal to about 0.7 and less than or equal to about 1.3, and the content (e.g., amount) of the boron element (B) in the coating layer is greater than or equal to about 1.0 wt % and less than or equal to about 21 wt % based on a total 100 wt % of the composite carbonaceous conductive material.

### CROSS-REFERENCE TO RELATED APPLICATION

This application claims priority to and the benefit of Japanese Patent Application No. 2024-022335, filed on Feb. 16, 2024, in the Japan Patent Office, and Korean Patent Application No. 10-2025-0016224, filed on Feb. 7, 2025, in the Korean Intellectual Property Office, the entire contents of each of which are incorporated herein by reference.

### BACKGROUND

### 1. Field

According to one or more embodiments, the present disclosure relates to composite carbonaceous conductive materials and non-aqueous electrolyte rechargeable batteries.

### 2. Description of the Related Art

Non-aqueous electrolyte rechargeable batteries, including rechargeable lithium-ion batteries, are widely used as power sources for smartphones, laptop computers, and/or the like. More recently, non-aqueous electrolyte rechargeable batteries have been developed for large-sized applications, such as in automobiles. These batteries (e.g., automotive batteries) are now designed for higher capacity and output, requiring higher voltages.

A positive electrode for the rechargeable lithium ion batteries contains a positive electrode active material, which is a main component, but also contains a carbonaceous conductive material, such as carbon nanotubes, to enhance electronic conductivity and/or the like.

In the high-voltage batteries, the positive electrode is in a high potential state and exposed to a strong oxidizing environment. If the carbonaceous conductive material in the positive electrode is placed in this high potential environment, it may deteriorate or undergo undesired side reactions (e.g., with the non-aqueous electrolyte of the rechargeable lithium-ion battery), generating an oxidation current that does not contribute to battery performance, thereby deteriorating overall battery performance.

Accordingly, to suppress or reduce the deterioration or the side reaction of the carbonaceous conductive material, a method of including a coating layer covering the surface of the carbonaceous conductive material is considered as described in Japanese Patent Publication No. 2004-099355 (Patent Document 1) and/or Japanese Patent Publication No. 2023-155562 (Patent Document 2). The entire contents of each of Patent Document 1 and 2 are incorporated herein by reference.

The information disclosed in this Background section is provided to enhance understanding of the background of the disclosure and may contain information that does not constitute prior art.

### SUMMARY

However, the method described in Patent Document 1 or 2 may not be sufficiently to suppress or reduce the deterioration and side reactions of the carbonaceous conductive material, especially under a high-voltage environment. The high-voltage environment refers to, for example, a voltage exceeding about 4.5 V or even about 5.0 V.

An aspect of the present disclosure has been made in consideration of the aforementioned difficulties or problems and is directed to provide a carbonaceous conductive material capable of sufficiently suppressing or reducing degradation and/or undesired side reaction(s) under a high-voltage environment. This aims to sufficiently suppress or reduce the generation of oxidation currents, even when the positive electrode of the high-voltage batteries is in the high-potential state and exposed to a strong oxidizing environment.

Additional aspects will be set forth in part in the description which follows and, in part, will be apparent from the description, or may be learned by practice of the presented embodiments of the disclosure.

One or more embodiments of the present disclosure include a composite carbonaceous conductive material that includes a carbon nanotube, and a coating layer on a surface of the carbon nanotube,
wherein the coating layer includes a nitrogen element (N), a boron element (B), and an oxygen element (O),
a weight ratio (B/N ratio) of a content (e.g., amount) of the boron element (B) to a content (e.g., amount) of the nitrogen element (N) in the coating layer may be greater than or equal to about 0.7 and less than or equal to about 1.3, and
the content (e.g., amount) of the boron element (B) in the coating layer may be greater than or equal to about 1.0 wt % and less than or equal to about 21 wt % based on a total 100 wt % of the composite carbonaceous conductive material.

In one or more embodiments, a total (sum) content (e.g., amount) of the nitrogen element (N) and the boron element (B) included in the coating layer may be greater than or equal to about 2.0 wt % and less than or equal to about 50.0 wt % based on the total 100 wt % of the composite carbonaceous conductive material.

In one or more embodiments, the coating layer may include boron nitride.

In one or more embodiments, the content (e.g., amount) of the boron element (B) included in the coating layer may be greater than or equal to about 2 wt % and less than or equal to about 15 wt % based on the total 100 wt % of the composite carbonaceous conductive material.

In one or more embodiments, the content (e.g., amount) of the boron element (B) included in the coating layer may be greater than about 3.6 wt % and less than or equal to about 10 wt % based on the total 100 wt % of the composite carbonaceous conductive material.

In one or more embodiments, a ratio ((B+N)/O ratio) of a sum of the content (e.g., amount) of the boron element (B) and the content (e.g., amount) of the nitrogen element (N) to the content (e.g., amount) of oxygen element (O) may be greater than or equal to about 0.5 and less than or equal to about 8.0.

In one or more embodiments, a thickness of the coating layer may be greater than or equal to about 0.3 nanometer (nm) and less than or equal to about 20 nm.

One or more embodiments of the present disclosure include a positive electrode for a rechargeable battery that includes a positive electrode active material, and a conductive material,
wherein the conductive material is the composite carbonaceous conductive material described herein.

In one or more embodiments, the positive electrode may include a sulfide solid electrolyte.

One or more embodiments of the present invention include a non-aqueous electrolyte rechargeable battery that includes a positive electrode, a negative electrode, a separator, and a non-aqueous electrolyte,
wherein the positive electrode is the positive electrode described herein.

In one or more embodiments, the non-aqueous electrolyte rechargeable battery may be charged and discharged at a voltage of greater than about 4.5 volt (V).

One or more embodiments of the present disclosure include a solid rechargeable battery that includes a positive electrode, a negative electrode, and a solid electrolyte layer,
wherein the positive electrode is the positive electrode described herein.

In one or more embodiments, the solid electrolyte layer includes a sulfide solid electrolyte.

In one or more embodiments, the solid rechargeable battery may be charged and discharged at a voltage of greater than about 4.5 V.

One or more embodiments of the present disclosure include a method of preparing a composite carbonaceous conductive material that includes providing a precursor layer that includes a boron oxide and a carbon nanotube, the boron oxide covering at least a portion of a surface of the carbon nanotube, for example, a precursor layer forming process in which a precursor layer of boron oxide is formed to cover a partial or entire surface of a carbon nanotube. The method also includes providing a nitridization to the boron oxide to form the precursor layer into a coating layer that includes a boron element (B) and a nitrogen element (N), for example, a nitriding process in which boron oxide forming the precursor layer is subjected to nitridization to form the precursor layer into a coating layer including a boron element and a nitrogen element.

In one or more embodiments, a weight ratio (B/N ratio) of a content (e.g., amount) of a boron element (B) to a content (e.g., amount) of nitrogen element (N) in the coating layer may be greater than or equal to about 0.7 and less than or equal to about 1.3, the content (e.g., amount) of boron element (B) in the coating layer may be greater than or equal to about 1.0 wt % and less than or equal to about 21 wt % based on 100 wt % of the composite carbonaceous conductive material.

In one or more embodiments, the providing the precursor layer may include dipping at least a surface of the carbon nanotube in a solution comprising the boron element (B); or coating the solution comprising the boron element (B) on at least one of the surface of the carbon nanotube. For example, the precursor layer forming process may include dipping the carbon nanotube in a solution including the boron element (B) on the surface, or coating a solution including the boron element (B) on the surface of the carbon nanotube.

In one or more embodiments, the coating layer may include boron nitride.

In one or more embodiments, a thickness of the coating layer may be greater than or equal to about 0.3 nm and less than or equal to about 20 nm.

One or more embodiments of the present disclosure include a composite carbonaceous conductive material that include a carbon nanotube and a coating layer on its surface. The coating layer includes nitrogen (N), boron (B), and oxygen (O) elements. The weight ratio (B/N ratio) of boron to nitrogen in the coating layer is between about 0.7 and about 1.3, and the boron content is between about 1.0 wt % and about 21 wt % of the total composite carbonaceous conductive material.

In some embodiments, the total content of nitrogen and boron in the coating layer is between about 2.0 wt % and about 50.0 wt % of the composite carbonaceous conductive material. The coating layer may include boron nitride. The boron content in the coating layer may range from about 2 wt % to about 15 wt %, or from about 3.6 wt % to about 10 wt % of the composite carbonaceous conductive material. Additionally, the ratio of the sum of boron and nitrogen to oxygen ((B+N)/O ratio) is between about 0.5 and about 8.0, and the coating layer thickness is between about 0.3 nm and about 20 nm.

The disclosure also includes a positive electrode for a rechargeable battery, including a positive electrode active material and the composite carbonaceous conductive material. This positive electrode may also include a sulfide solid electrolyte. A non-aqueous electrolyte rechargeable battery is described, which includes a positive electrode, a negative electrode, a separator, and a non-aqueous electrolyte, with the positive electrode being the one described herein. This battery may be charged and discharged at voltages greater than about 4.5 V.

Furthermore, the disclosure includes a solid rechargeable battery with a positive electrode, a negative electrode, and a solid electrolyte layer, where the positive electrode is as described. The solid electrolyte layer may include a sulfide solid electrolyte, and the battery may be charged and discharged at voltages greater than about 4.5 V.

A method of preparing the composite carbonaceous conductive material is also provided. This method involves forming a precursor layer of boron oxide on the carbon nanotube and then nitridizing the boron oxide to form a coating layer that includes boron and nitrogen. The weight ratio (B/N ratio) of boron to nitrogen in the coating layer is between about 0.7 and about 1.3, and the boron content is between about 1.0 wt % and about 21 wt % of the composite carbonaceous conductive material.

The precursor layer may be formed by dipping the carbon nanotube in a solution containing boron or by coating the solution on the carbon nanotube's surface. The coating layer may include boron nitride, and its thickness can range from about 0.3nm to about 20 nm.

According to the present disclosure, this composite carbonaceous conductive material may effectively suppress or reduce deterioration and side reactions in high-voltage environments, thereby improving battery performance.

According to the present disclosure, even when the positive electrode of a high-voltage battery is in a high-potential state and is exposed to a strong oxidizing environment, it is possible to provide a carbonaceous conductive material capable of sufficiently suppressing or reducing deterioration and side reactions of the carbonaceous conductive material under a high-voltage environment and sufficiently suppressing or reducing the generation of oxidation current.

### BRIEF DESCRIPTION OF THE DRAWINGS

FIG. 1 is a schematic view illustrating a non-aqueous electrolyte rechargeable battery according to some example embodiments.

FIG. 2 is a cross-sectional view of an all-solid-state rechargeable battery according to some example embodiments.

### DETAILED DESCRIPTION

In order to sufficiently understand the configuration and effect of the present disclosure, one or more embodiments will be described in more detail with reference to the accompanying drawings so that those of ordinary skill in the art can easily implement them. It should be noted, however, that the present disclosure is not limited to the following example embodiments, and may be implemented and embodied in many different forms and is not construed as limited to the example embodiments set forth herein. Rather, the example embodiments are provided only to disclose the present disclosure and let those skilled in the art fully know the scope of the present disclosure.

The terminology used herein is used to describe embodiments only, and is not intended to limit the present disclosure. The singular expression includes the plural expression unless the context clearly dictates otherwise.

As used herein, “combination thereof” refers to a mixture, a laminate, a composite, a copolymer, an alloy, a blend, a reaction product, and/or the like of the constituents.

Here, it should be understood that terms such as “comprising,” “comprise,” “comprises,” “including,” “include,” “includes,” “having,” “has,” and/or “have” are intended to designate the presence of an embodied feature, number, (e.g., act or task) step, element, and/or a (e.g., any suitable) combination thereof, but do not preclude the possibility of the presence or addition of one or more other features, number, (e.g., act or task) step, element, and/or a (e.g., any suitable) combination thereof. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof. Moreover, in this context, “consisting essentially of” indicates that any additional components will not materially affect the chemical, physical, optical or electrical properties of the semiconductor film.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

In the drawings, the thickness of layers, films, panels, regions, and/or the like, are exaggerated for clarity and like reference numerals designate like elements throughout, and duplicative descriptions thereof may not be provided the specification. It will be understood that if (e.g., when) an element such as a layer, film, region, or substrate is referred to as being “on” another element, it can be directly on the other element or intervening elements may also be present. In contrast, if (e.g., when) an element is referred to as being “directly on” another element, there are no intervening elements present.

In some embodiments, “layer” herein includes not only a shape formed on the whole surface if (e.g., when) viewed from a plan view, but also a shape formed on a partial surface.

Herein, unless otherwise specially noted, the phrase “A or B” is not to be construed as an exclusive meaning, for example, the phrase “A or B” may indicate “A but not B”, “B but not A”, and “A and B,” and/or the like.

“Metal” is interpreted as a concept including ordinary metals, transition metals and metalloids (semi-metals).

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In the context of the present application and unless otherwise defined, the terms “use,” “using,” and “used” may be considered synonymous with the terms “utilize,” or “utilization,” “utilizing,” and “utilized,” respectively.

Hereinafter, one or more embodiments of a rechargeable battery is described.

### 1. Basic Configuration of Rechargeable Battery

A rechargeable battery according to some example embodiments may be a rechargeable lithium ion battery including a positive electrode, a negative electrode, a separator, a non-aqueous electrolyte, and a case accommodating them therein.

The shape of the rechargeable lithium ion battery is not particularly limited, but may be any shape, such as cylindrical, square, laminated, or button.

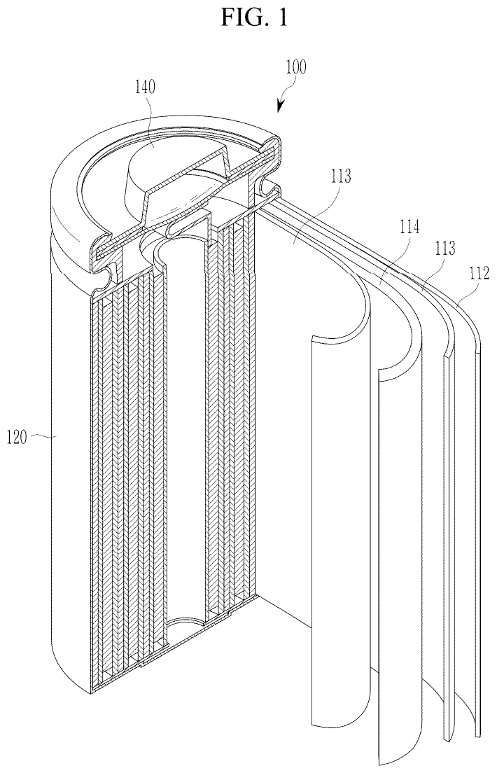

Hereinafter, a non-aqueous electrolyte rechargeable battery according to some example embodiments is described with reference to FIG. 1.

FIG. 1 is a schematic view illustrating a non-aqueous electrolyte rechargeable battery according to some example embodiments.

Referring to FIG. 1, a rechargeable lithium battery 100 according to some example embodiments includes a battery cell including a positive electrode 114, a negative electrode 112 opposite to (e.g., facing) the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

A rechargeable battery according to some example embodiments may be an all-solid-state rechargeable battery including a positive electrode, a negative electrode, and a solid electrolyte layer between the positive electrode and the negative electrode. The all-solid-state rechargeable battery may also be expressed as an all-solid-state battery or an all-solid-state rechargeable lithium battery.

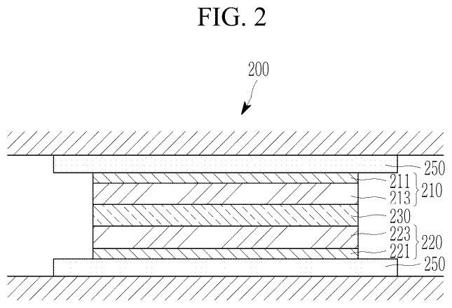

FIG. 2 is a cross-sectional view of an all-solid-state rechargeable battery according to some example embodiments. Referring to FIG. 2, an all-solid-state rechargeable battery 200 may have a structure in which an electrode assembly in which a negative electrode 220 including a negative electrode current collector 221 and a negative electrode active material layer 223, a solid electrolyte layer 230, and a positive electrode 210 including a positive electrode active material layer 213 and a positive electrode current collector 211 are laminated is housed in a case such as a pouch. The all-solid-state rechargeable battery 100 may further include an elastic layer 250 on the outer side of at least one of the positive electrode 210 and the negative electrode 220. FIG. 2 illustrates one electrode assembly including a negative electrode 220, a solid electrolyte layer 230, and a positive electrode 210, but an all-solid-state battery may be manufactured by stacking two or more electrode assemblies.

### 1-1. Positive Electrode

The positive electrode may include a positive electrode current collector and a positive electrode mixture layer formed on the positive electrode current collector.

The positive electrode current collector may be any conductor that is an electrical (electron) conductor, and may be, for example, plate-shaped and/or thin-shaped. In one or more embodiments, the positive electrode current collector may be made of aluminum, stainless steel, nickel-coated steel, and/or the like.

The positive electrode mixture layer may include a positive electrode active material, and may further include a conductive agent (electrical conductor) and a positive electrode binder.

The positive electrode active material may be, for example, a transition metal oxide including (e.g., containing) lithium and/or a solid solution oxide, and is not particularly limited as long as it is a material capable of electrochemically intercalating and deintercalating lithium ions. The shape of the positive electrode active material is not particularly limited, and may be in the form of particles.

Examples of the transition metal oxide containing lithium may include Li_{1.0}Ni_{0.88}Co_{0.1}Al_{0.01}Mg_{0.0102}, and/or the like. In some embodiments, it may include Li·Co-based composite oxides such as LiCoO₂, and/or the like, Li·Ni·Co—Mn-based composite oxides such as LiNiₓCo_{y}Mn_{z}O₂, and/or the like, Li—Ni-based composite oxides, such as LiNiO₂, and/or the like, or Li—Mn-based composite oxides, such as LiMn₂O₄, and/or the like. Examples of the solid solution oxide may include, LiₐMnₓCo_{y}Ni_{z}O₂ (1.150≤a≤1.430, 0.45≤x≤0.6, 0.10≤y≤0.15, 0.20≤z≤0.28), LiMn_{1.5}Ni_{0.5}O₄, and/or the like. The content (e.g., amount) (content (e.g., amount) ratio) of the positive electrode active material is not particularly limited, and any content (e.g., amount) applicable to the positive electrode mixture layer of the non-aqueous electrolyte rechargeable battery may be sufficient. Moreover, these compounds may be used independently, or plural types (kinds) may be mixed and used.

The positive electrode mixture layer according to the present embodiment includes, as the conductive material, a composite carbonaceous conductive material described in more detail later.

Examples of the conductive material may include, in addition to the composite carbonaceous conductive material described in more detail, at least one selected from among carbon black, natural graphite, artificial graphite, fiber-shaped carbon, and sheet-shaped carbon.

Examples of the carbon black may include furnace black, channel black, thermal black, Ketjen black, and acetylene black.

Examples of the fiber-shaped carbon include a carbon nanotube, a carbon nanofiber, and/or the like, and examples of sheet-shaped carbon may include graphene, and/or the like.

A content (e.g., amount) of the conductive material in the positive electrode mixture layer is not particularly limited, but from the viewpoint of achieving both (e.g., simultaneously) conductivity and battery capacity, it may be greater than or equal to about 0.005 wt % and less than or equal to about 5 wt %, greater than or equal to about 0.1 wt % and less than or equal to about 3 wt %, and greater than or equal to about 0.1 wt % and less than or equal to about 2 wt % based on a total weight of the positive electrode mixture layer.

The content (e.g., amount) of this conductive material is the total content (e.g., amount) of multiple types (kinds) of conductive materials if (e.g., when) the positive electrode includes multiple types (kinds) of conductive materials.

Examples of the positive electrode binder may include a fluorine-containing resin such as polyvinylidene fluoride, an ethylene-containing resin such as a styrene-butadiene rubber, and an ethylene-propylene-diene terpolymer), an acrylonitrile-butadiene rubber, a fluororubber, polyvinyl acetate, polymethylmethacrylate, polyethylene, polyvinyl alcohol, carboxy methyl cellulose or carboxy methyl cellulose derivatives (such as a salt of carboxymethyl cellulose), or nitrocellulose.

The positive electrode binder may be any binder capable of binding the positive electrode current collector and the conductive material on the positive current collector, and is not particularly limited.

### 1-2. Negative Electrode

The negative electrode includes a negative electrode current collector and a negative electrode mixture layer formed on the negative electrode current collector.

The negative electrode current collector may be any conductor that is an electrical conductor, and may be, for example, plate-shaped and/or thin-shaped, and may include (be composed of) copper, stainless steel, nickel-plated steel, and/or the like.

The negative electrode mixture layer includes a negative electrode active material and may additionally include a conductive material and a negative electrode binder.

The negative electrode active material is not particularly limited as long as it can electrochemically intercalate and deintercalate lithium ions, and examples thereof include a graphite active material (artificial graphite, natural graphite, a mixture of artificial graphite and natural graphite, natural graphite coated with artificial graphite, and/or the like), a Si-based active material or a Sn-based active material (for example, a mixture of particulates of silicon (Si) or tin (Sn) or oxides thereof and a graphite active material, particulates of silicon or tin, an alloy using silicon or tin as a base material), metallic lithium and titanium oxide compounds such as Li₄Ti₅O₁₂, lithium nitride, and/or the like.

As a negative electrode active material, one type (kind) among the preceding

may be used, or two or more types (kinds) may be used in combination. In one or more embodiments, silicon oxide is represented by SiOₓ (0≤x≤2).

The conductive material is not particularly limited as long as it is used to increase the conductivity of the cathode, and for example, substantially the same material as described for the positive electrode may be used.

A content (e.g., amount) of the conductive material in the negative electrode mixture layer is not particularly limited, but from the viewpoint of achieving both (e.g., simultaneously) conductivity and battery capacity, it may be greater than or equal to about 0.005 wt % and less than or equal to about 5 wt %, for example greater than or equal to about 0.1 wt % and less than or equal to about 3 wt % based on a total weight of the total negative electrode mixture layer.

As the negative electrode binder, any binder capable of binding the negative electrode active material and the conductive material onto the negative electrode current collector may be used, and is not particularly limited.

The negative electrode binder may include, for example, polyvinylidene fluoride (PVDF), polytetrafluoroethylene (PTFE), polyacrylic acid (PAA), styrene butadiene-based copolymer (SBR), a metal salt of carboxymethyl cellulose (CMC), and/or the like. One type (kind) of binder may be used alone or two or more types (kinds) may be used.

### 1-3. Separator

The separator is not particularly limited, and any separator may be used as long as it is used as a separator of a rechargeable lithium ion battery. The separator may be a porous film or a nonwoven fabric having excellent or suitable high rate discharge performance that may be used alone or with other materials.

Examples of the resin constituting the separator may include a polyolefin-based resin such as polyethylene and polypropylene; a polyester-based resin such as polyethylene terephthalate and polybutylene terephthalate; polyvinylidene difluoride, a vinylidene difluoride-hexafluoropropylene copolymer, a vinylidene fluoride-perfluorovinylether copolymer, a vinylidene difluoride-tetrafluoroethylene copolymer, a vinylidene difluoride-trifluoroethylene copolymer, a vinylidene fluoride-fluoroethylene copolymer, a fluoride vinylidene-hexafluoroacetone copolymer, a vinylidene difluoride-ethylene copolymer, a vinylidene difluoride-propylene copolymer, a vinylidene fluoride-vinylidene difluoride-trifluoro propylene copolymer, a vinylidene difluoride-tetrafluoroethylene copolymer, a vinylidene fluoride-ethylene-tetrafluoroethylene copolymer, or a vinylidene difluoride-ethylene-tetrafluoroethylene copolymer.

In contrast, the porosity of the separator is not particularly limited, and may be any suitable porosity for a separator of a rechargeable lithium ion battery.

The separator may additionally have a surface layer coating the surface of the aforementioned porous film or nonwoven fabric. The surface layer may include an adhesive for fixing the battery element by adhering to the electrode. Examples of the adhesive may include a vinylidene fluoride-hexafluoropropylene copolymer, an acid-modified product of a vinylidene fluoride polymer, and a styrene-(meth)acrylic acid ester copolymer.

### 1-4. Non-aqueous Electrolytic Solution

For the non-aqueous electrolyte solution, a conventionally used non-aqueous electrolyte solution for a rechargeable lithium ion battery may be used without particular limitation. The non-aqueous electrolyte solution may have a composition in which an electrolytic salt is included (contained) in a non-aqueous solvent that is a solvent for an electrolyte solution.

The non-aqueous solvent may include, for example, cyclic carbonate esters such as propylene carbonate, ethylene carbonate, butylene carbonate, chloroethylene carbonate, fluoroethylene carbonate, or vinylene carbonate, cyclic esters such as γ-butyrolactone or γ-valerolactone, linear carbonates such as dimethyl carbonate, diethyl carbonate, or ethylmethyl carbonate, linear esters such as methyl formate, methyl acetate, methyl butyrate, ethyl propionate, or propyl propionate, ethers such as tetrahydrofuran or a derivative thereof, 1,3-dioxane, 1,4-dioxane, 1,2-dimethane, 1,2-dimethoxyethane, 1,4-dibutoxyethane, or methyldiglyme, ethylene glycol monopropyl ether, or propylene glycol monopropyl ether, nitriles such as acetonitrile and benzonitrile, dioxolane or a derivative thereof, ethylene sulfide, sulfolane, sultone, or a derivative thereof, which may be used alone or in a mixture of two or more.

In contrast, if (e.g., when) two or more of the non-aqueous solvents are mixed and used, the mixing ratio of each non-aqueous solvent may be a mixing ratio suitable to be used in a rechargeable lithium ion battery.

Examples of the electrolytic salt may include an inorganic ion salt including lithium (Li), sodium (Na), or potassium (K) such as LiCIO₄, LiBF₄, LiAsF₆, LiPF₆, LIPF₆₋ₓ(CnF₂ₙ₊₁)ₓ [provided that 1<x<6, n=1 or 2], LiSCN, LiBr, LiI, Li₂SO₄, Li₂B₁₀Cl₁₀, NaClO₄, NaI, NaSCN, NaBr, KClO₄, or KSCN, and an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NCIO₄, (n-C₄H₉)₄NI, (C₂H₅)₄N-maleate, (C₂H₅)₄N-benzoate, (C₂H₅)₄N-phtalate, lithium stearyl sulfate, lithium octyl sulfate, or lithium dodecyl benzene sulfonate, and these ionic compounds may be used alone or in a mixture of two or more.

In contrast, the concentration of the electrolyte salt may be substantially the same as in the non-aqueous electrolyte solution used in a suitable rechargeable lithium ion battery, without particular limitation.

In one or more embodiments, the non-aqueous electrolyte solution may include the aforementioned lithium compound (electrolytic salt) at a concentration of greater than or equal to about 0.8 molarity (M) and less than or equal to about 1.5 (M).

In one or more embodiments, one or more suitable additives may be added to the non-aqueous electrolyte solution.

Examples of such additives may include an additive suitable for a negative electrode, an additive suitable for a positive electrode, an ester-based additive, a carbonate ester-based additive, a sulfuric acid ester-based additive, a phosphoric acid ester-based additive, a boric acid ester-based additive, an anhydride-based additive, and an electrolyte-based additive.

One of these may be added to the non-aqueous electrolyte, or a plurality of types (kinds) of additives may be added to the non-aqueous electrolyte.

### 2. Characteristics of Non-Aqueous Electrolyte Rechargeable Battery According to the Present Embodiment

Hereinafter, the configuration of the non-aqueous electrolyte rechargeable battery according to the present embodiment is described.

The positive electrode mixture layer of the non-aqueous electrolyte rechargeable battery according to the present embodiment includes a composite carbon-based conductive material as a conductive material, for example, a composite carbonaceous conductive material may be the only conductive material.

This composite carbonaceous conductive material includes a carbon nanotube and a coating layer on a surface of the carbon nanotubes. For example, the carbon nanotube and the coating layer on the surface of the carbon nanotube may be combined to form an integral whole.

As for the carbon nanotube, there are no particular limitations and one or more suitable types (kinds) can be used as long as it can be used as a conductive material in rechargeable batteries. For example, as the carbon nanotube, a single-layer carbon nanotube or a multilayer carbon nanotube having two or more layer structures may be used.

As carbon nanotubes included in composite carbonaceous conductive materials, commercially available products may be widely used. The outer diameter of the carbon nanotube may be about 0.4 nm to about 50 nm, because conductivity may be increased within the described range. Additionally, the length of the carbon nanotube may be about 100 nm to about 5 mm, for example about 1 um to about 3 mm. In the described ranges, the formation of a conductive path (pass) in the positive electrode mixture layer may be enhanced or improved.

The coating layer may include a nitrogen element (N) and a boron element (B), and a weight ratio (B/N ratio) of a content (e.g., amount) of the boron element (B) to a content (e.g., amount) of the nitrogen element (N) in the coating layer may be greater than or equal to about 0.7 and less than or equal to about 1.3. The B/N weight ratio may be greater than or equal to about 0.7 and less than or equal to about 0.9, for example greater than or equal to about 0.7 and less than or equal to about 0.85.

The coating layer may also include an oxygen element (O), and it may be suitable to select or adjust the weight ratio ((B+N)/O ratio) of the content (e.g., amount) of the boron element (B) and the nitrogen element (N) to the content (e.g., amount) of the oxygen element (O) in the composite carbonaceous conductive material to be greater than or equal to about 0.5 and less than or equal to about 8.0. The (B+N)/O weight ratio may be greater than or equal to about 0.7 and less than or equal to about 3.0, for example greater than or equal to about 1.0 and less than or equal to about 2.5.

It is considered that the oxygen element may be derived from boric acid initially added to the carbon nanotube if (e.g., when) forming the coating layer of the composite carbonaceous conductive material according to the present embodiment.

Examples of such a coating layer may include, for example, those including boron nitride, and for example, those formed by chemically stable boron nitride.

The coating layer may be single-layer or multi-layer. For example, if (e.g., when) the coating layer includes boron nitride, it is considered that the boron nitride is in the form of energetically very stable hexagonal boron nitride (h-BN).

In one or more embodiments, the h-BN may have a layered structure, e.g., substantially similar to graphite or carbon nanotube, and if (e.g., when) the amount of boron nitride included in the coating layer is relatively large, there may be a possibility that the coating layer has a multilayer structure due to the layered structure of the boron nitride.

The content (e.g., amount) of boron element (B) included in the coating layer may be greater than or equal to about 1.0 wt % and less than or equal to about 21 wt % based on a total 100 wt % of the composite carbonaceous conductive material.

The content (e.g., amount) of boron element (B) included in the coating layer may be greater than or equal to about 2.0 wt % and less than or equal to about 15 wt %, greater than or equal to about 2.5 wt % and less than or equal to about 15 wt %, greater than or equal to about 3.6 wt % and less than or equal to about 10 wt %, or greater than or equal to about 3.6 wt % and less than or equal to about 4.5 wt % based on a total 100 wt % of the composite carbonaceous conductive material.

The total content (e.g., amount) of boron element (B) and nitrogen element (N) included in the coating layer may be greater than or equal to about 2 wt % and less than or equal to about 50 wt % based on a total 100 wt % of the composite carbonaceous conductive material.

For example, if (e.g., when) the coating layer is formed of boron nitride alone as described herein, the total content (e.g., amount) of (e.g., a sum of) the boron element (B) and the nitrogen element (N) included in the coating layer may be greater than or equal to about 5.8 wt % and less than or equal to about 48 wt % based on a total 100 wt % of the composite carbonaceous conductive material.

A thickness of the coating layer may be greater than or equal to about 0.3 nm and less than or equal to about 20 nm, greater than or equal to about 0.3 nm and less than or equal to about 18 nm, greater than or equal to about 0.3 nm and less than or equal to about 17 nm, or greater than or equal to about 0.3 nm and less than or equal to about 10 nm.

In some embodiments, if (e.g., when) the coating layer is formed of an insulating material such as boron nitride, the conductivity of the positive electrode mixture layer may be sufficiently maintained by setting the thickness of the coating layer to about 20 nm.

In some embodiments, by making the thickness of the coating layer 0.3 nm or more, suppression or reduction of deterioration of the carbon nanotubes or undesired side reaction(s) with other battery components, such as electrolytes, may be sufficiently exerted.

In one or more embodiments, the thickness of 0.3 nm may be substantially about the same as the thickness of one layer of h-BN, which is suitable to have substantially the same hexagonal crystal structure as graphite.

The thickness of the coating layer may be controlled or selected, for example, by changing the amount of boric acid added to the carbon nanotube if (e.g., when) forming the coating layer.

The coating layer may be formed in an island shape on a part of the surface of the carbon nanotube, but it is desirable to uniformly (e.g., substantially uniformly) coat the entire surface of the carbon nanotube to a degree where the carbon nanotube and the non-aqueous electrolyte or solid electrolyte cannot come into direct contact.

It may be desirable to adjust the content (e.g., amount) of the composite carbonaceous conductive material in the positive electrode mixture layer so that the content (e.g., amount) of the entire conductive material is within the range of the total content (e.g., amount) of the conductive material in the positive electrode mixture layer described herein. In one or more embodiments, from the viewpoint of manufacturing cost, the content (e.g., amount) of the composite carbonaceous conductive material in the positive electrode mixture layer may be greater than or equal to about 0.005 wt % and less than or equal to about 3.0 wt %, for example greater than or equal to about 0.005 wt % and less than or equal to about 2.0 wt %.

### 3. Method of Manufacturing Non-Aqueous Electrolyte Rechargeable Battery

Next, a method for manufacturing a non-aqueous electrolyte rechargeable battery according to the present embodiment is described.

### 3-1. Method for Preparing Composite Carbonaceous Conductive Material

The composite carbonaceous conductive material may be prepared by, for example, a method including providing a precursor layer that includes a boron oxide and a carbon nanotube, the boron oxide covering at least a portion of a surface of the carbon nanotube (e.g., a precursor layer forming process in which a precursor layer of boron oxide is formed to cover a partial or entire surface of a carbon nanotube). In one or more embodiments, the boron oxide may cover a partial (e.g., a portion of the) surface of the carbon nanotube, or may cover an entire (e.g., all of the) surface of the carbon nanotube.

The method includes providing a nitridization to the boron oxide to form the precursor layer into a coating layer that includes a boron element (B) and a nitrogen element (N) (e.g., a nitriding process in which boron oxide forming the precursor layer is subjected to nitridization to form the precursor layer into a coating layer including a boron element and a nitrogen element).

For example, the method of preparing a composite carbonaceous conductive material includes: providing a precursor layer comprising boron oxide and a carbon nanotube, the boron oxide covering at least a portion of the surface of the carbon nanotube; and nitridizing the boron oxide to form a coating layer on the carbon nanotube, the coating layer comprising boron (B) and nitrogen (N),

The method (e.g., precursor layer forming process) may include, for example, dipping at least a surface of the carbon nanotube in a solution including the boron element (B) (e.g., on the surface), or coating a solution including the boron element (B) on the surface of carbon nanotube.

The carbon nanotubes that are attached to the surface of the solution in this way may be dried, for example, by natural drying, to form a precursor layer. The phrase “natural drying” may refer to a process that excludes the use of heat, an airstream, and/or vacuum.

In one or more embodiments, as a solution including the boron element (B), there is no particular limitation, but examples thereof include a compound including boron dissolved in an appropriate or suitable solvent. Examples of compounds including boron include boric acid.

In some embodiments, as a solvent that dissolves boric acid, examples thereof include solvents that can be volatilized by natural drying, such as ethanol, but it is of course not limited to combinations thereof.

The precursor layer can be stably supported on the surface of the carbon nanotube, for example, after the aforementioned natural drying, or by heating under an inert gas atmosphere such as argon instead of natural drying.

The heating temperature and heating time thereof may be appropriately or suitably changed, but for example, it is desirable to heat at a temperature of greater than or equal to about 200° C. and less than or equal to about 600° C. for greater than or equal to about 5 minutes and less than or equal to about 60 minutes, for example greater than or equal to about 300° C. and less than or equal to about 500° C. for greater than or equal to about 15 minutes and less than or equal to about 45 minutes.

The precursor layer formed on the surface of the carbon nanotube in the manner described herein includes boron oxide, and thus a coating layer is formed by performing a nitriding process (e.g., nitridization) to add nitride to the boron oxide.

This nitriding process may be performed by heating the herein-mentioned precursor layer in an atmosphere of a gas that includes (containing) a nitrogen element, such as ammonia gas.

The heating temperature and heating time thereof may be appropriately or suitably changed, but for example, it is desirable to be at a temperature of greater than or equal to about 800° C. and less than or equal to about 1500° C. for greater than or equal to about 5 minutes and less than or equal to about 90 minutes, for example greater than or equal to about 1000° C. and less than or equal to about 1200° C. for greater than or equal to about 15 minutes and less than or equal to about 60 minutes.

### 3-2. Method of Manufacturing Positive Electrode

The positive electrode is manufactured, for example, as follows:

First, a composite carbonaceous conductive material manufactured as described herein, a positive electrode active material, and a positive electrode binder are mixed in a desired or suitable ratio and dispersed in a positive electrode slurry solvent to form a positive electrode slurry.

Next, the positive electrode slurry is coated onto the positive electrode current collector and dried to form a positive electrode mixture layer.

In some embodiments, the coating method is not specifically limited. The coating method may be, for example, a knife coater method, a gravure coater method, a reverse roll coater method, or a slit die coater method. Each of the coating method may be also performed by the same method.

Next, the positive electrode material mixture layer may be pressed to a desired or suitable density by a press machine. Thereby, a positive electrode is manufactured.

### 3-3. Method of Manufacturing Negative Electrode

The negative electrode may be also manufactured in substantially the same way as the positive electrode.

First, a negative electrode slurry is prepared by dispersing a mixture of materials constituting the negative electrode mixture layer in a solvent for negative electrode slurry.

Then, the negative electrode slurry is coated onto the negative current collector and dried to form a negative electrode mixture layer.

Subsequently, the negative electrode mixture layer is pressed to a desired or suitable density with a press machine.

Accordingly, a negative electrode is manufactured.

### 3-4. Method for Manufacturing a Non-Aqueous Electrolyte Rechargeable Battery

Subsequently, an electrode structure is produced by sandwiching a separator between the positive electrode and the negative electrode.

Then, the electrode structure is processed into a desired or suitable shape (e.g., cylindrical, prismatic, laminated, buttoned, and/or the like), and inserted into a container of the described shape.

Then, by injecting the non-aqueous electrolyte solution into the container, the electrolyte is impregnated into the pores in the separator and the voids of the positive electrode and the negative electrode.

By the described process, a rechargeable lithium ion battery may be

manufactured.

### 4. Effects of the Present Embodiment

According to the non-aqueous electrolyte rechargeable battery configured as described herein, even if (e.g., when) the positive electrode in a high-voltage battery is in a high-potential state and is placed in a strong oxidizing environment, it is possible to provide a composite carbonaceous conductive material, a positive electrode for a rechargeable battery, and a non-aqueous electrolyte rechargeable battery capable of sufficiently suppressing or reducing deterioration and side reactions of the carbonaceous conductive material under a high-voltage environment and sufficiently suppressing or reducing the generation of oxidation current.

### 5. Another Embodiment of Present Disclosure

The present disclosure is not limited to the aforementioned embodiments.

In the aforementioned embodiments, the composite carbonaceous conductive material is included in the positive electrode mixture layer, but the composite carbonaceous conductive material according to some example embodiments may be included in another layer constituting the rechargeable battery, for example, a protective layer protecting the negative electrode mixture layer or the positive electrode mixture layer.

In some embodiments, in the aforementioned embodiments, the case of a non-aqueous electrolyte rechargeable battery having a separator and an electrolyte has been described as an example of a rechargeable battery, but the present disclosure is not limited thereto, and the composite carbonaceous conductive material according to the present disclosure can be widely used as a conductive material in a semi-solid battery having a gel-type (kind) electrolyte, a solid battery having a solid electrolyte layer made of a sulfide solid electrolyte, and/or the like, an all-solid-state battery that does not include an electrolyte at all, and/or the like.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

In some embodiments, the present disclosure is not limited to these embodiments, and one or more suitable modifications are possible without departing from the scope thereof.

### EXAMPLES

Hereinafter, the present disclosure will be described in more detail with specific examples. However, the following examples are merely examples of the present disclosure, and the present disclosure is not limited to the following examples.

In the following examples, first, composite carbonaceous conductive materials having the properties shown in Table 1 were manufactured. Using these, non-aqueous electrolyte rechargeable batteries and solid rechargeable batteries were manufactured, and the generation of oxidation current was investigated for each manufactured battery.

### Preparation of Composite Carbonaceous Conductive Material

### Example 1

First, 0.48 gram (g) of boric acid was dispersed in 10 milliliter (mL) of ethanol to prepare a boric acid-ethanol solution. Subsequently, 450 milligram (mg) of multiwall carbon nanotubes (MWCNTs) manufactured by Sigma-Aldrich Co., Ltd. was added to the boric acid-ethanol solution and then, naturally dried overnight at room temperature, while stirring, to manufacture MWCNTs supported with boric acid.

Next, the temperature was raised to 400° C. in a tube electric furnace under an argon atmosphere and then, maintained for 30 minutes to prepare MWCNTs supported with boron oxide.

Then, the MWCNTs supported with boron oxide were coated with boron nitride by performing a nitridization (nitriding treatment) at 1100° C. for 40 minutes under a mixed gas of ammonia/argon in a ratio (e.g., amount) of 1:4 to manufacture, obtaining a composite carbonaceous conductive material (A).

### Example 2

10 mg of the MWCNTs of Example 1 was dispersed in 140 mL of 2-propanol, suction-filtered on a membrane filter, vacuum-dried at 120° C., and then, punched out into a 11 mmϕ circle (e.g., a circle having a diameter of about 11 millimeter (mm)) to obtain a MWCNT film.

Subsequently, a self-supporting film-type (kind) composite carbonaceous conductive material (B) was obtained in substantially the same manner as in Example 1, except that the MWCNT film was dipped in a boric acid aqueous solution prepared by dispersing 0.48 g of boric acid in 10 ml of water for 85 minutes to prepare the MWCNT film supported with boric acid.

### Example 3

A composite carbonaceous conductive material (C) was obtained in substantially the same manner as in Example 1 except that the content (e.g., amount) of MWCNTs was changed to 230 mg.

### Example 4

A composite carbonaceous conductive material (D) was obtained in substantially the same manner as in Example 1 except that the content (e.g., amount) of MWCNTs was changed to 90.5 mg.

### Comparative Example 1

The composite carbonaceous conductive material was non-coated multiwall carbon nanotubes (MWCNTs).

### Comparative Example 2

A composite carbonaceous conductive material (E) was obtained in substantially the same manner as in Example 1 except that the content (e.g., amount) of MWCNTs was changed to 22.7 mg.

### Evaluation of Composite Carbonaceous Conductive Material

The composite carbonaceous conductive materials of Examples 1 and 2 and Comparative Examples 1 and 2 were evaluated as follows.

### Elemental Analysis

Each of the composite carbonaceous conductive materials was quantitatively analyzed by measuring each boron and nitrogen amount according to JIS K0152:2014 by using an X-ray photoelectron spectroscopy device (XPS, ESCALAB 250Xi made by Thermo Fisher Scientific).

As a result of the quantitative analysis, a coating layer of each composite carbonaceous conductive material was confirmed to include (be composed of) boron and nitrogen elements and oxygen, and the contents (e.g., amounts) of the boron, nitrogen and oxygen elements, and the total content (e.g., amount) of the nitrogen and boron elements in the composite carbonaceous conductive material are shown in Table 1.

In contrast, the oxygen was contained in the carbon nanotubes as well as the coating layer, but the nitrogen and boron elements were contained in the coating layer alone.

In some embodiments, in the coating layer, some of its constituent elements were chemically bonded between the carbon nanotubes to support them, which was observed by the XPS.

An example of the chemical bond, in addition to a covalent bond (N—C) between nitrogen elements constituting the coating layer and carbon elements constituting the CNT, the chemical bond was also inferred to include a bond (B—O—C) mediated by oxygen elements between boron elements and carbon elements according to information such as a ratio of a covalent bond (B—O) between boron and oxygen, a covalent bond (O—C) between oxygen and carbon and/or the like.

### Measurement of Thickness of Coating Layer

Each of the composite carbonaceous conductive materials was measured with respect of a thickness of the coating layer as follows.

First, the composite carbonaceous conductive material was taken an image by transmission electron microscopy (TEM) and an elemental mapping image of by electron energy loss spectroscopy (EELS).

Herein, a field emission-type (kind) transmission electron microscope (JEM-ARM200F, JOEL Ltd.) and an electron energy loss spectrometer (GIF QUANTUM ER, Gatan, inc.) were used.

Among the composite carbonaceous conductive materials included in these TEM images, the thickness of the coating layer of the composite carbonaceous conductive material that can be identified from the transmission observation image and the element mapping image was measured at 10 locations, and the average value of these was taken as the thickness of the coating layer.

### Evaluation of Sheet Resistance

As described herein, 5 mg of any one type (kind) of the carbonaceous conductive materials according to Examples 1, 3, and 4 and Comparative Examples 1 and 2 was dispersed in 30 mL of a sodium dodecylbenzenesulfonate (SDBS) aqueous solution and then, suction-filtered on a membrane filter. The carbonaceous conductive materials according to Example 1 and Comparative Example 1 were peeled off from the membrane filter, vacuum-dried at 120° C., and cut out into a 11 mmϕ circle to obtain a self-supporting membrane.

The carbonaceous conductive materials according to Examples 3 and 4 and Comparative Example 2 were not peeled off from the membrane filter but naturally dried at room temperature to prepare samples for measuring sheet resistance. These film samples and the film of Example 2 were respectively measured and compared with respect to sheet resistance (e.g., surface resistivity) by using a voltage-current generation-measuring apparatus (2400 series source meter, Keithley Instruments, LLC) in a four-probe method. The results are shown in Table 1.

### Evaluation of Withstanding Voltage: Cyclic Voltammetry (CV) Measurement (1 and 2): Non-Aqueous Electrolyte

### Manufacturing of Positive Electrode Self-Supporting Film for Evaluation

As described herein, 5 mg of any one type (kind) of the carbonaceous conductive materials (carbon nanotubes (MWCNTs) with no coating layer) according to Examples 1 and 2 and Comparative Example 1 was dispersed in 30 mL of a 0.5 wt % SDBS aqueous solution, suction-filtered on a membrane filter, vacuum-dried at 120° C., and cut out into a 11 mmϕ circle to obtain a self-supporting film, which was used as a positive electrode for CV (1) evaluation.

### Manufacturing of Counter Electrode, Electrolyte, and Coin Cell for CV (1)

A porous separator made of polypropylene and a counter electrode made of metal lithium were cut out into a size suitable for a coin cell.

Each coin cell (2032) of Examples 1 and 2 and Comparative Example 1 for the CV (1) evaluation was manufactured, as shown in Table 1, by using an electrolyte prepared by dissolving 1.0 molarity (M) LiPF6 in a mixed solvent of ethylene carbonate/diethyl carbonate in a volume ratio of 50/50, the positive electrode for the CV evaluation, and the aforementioned separator and counter electrode.

### Manufacturing of Electrolyte, and Coin Cell for CV (2)

Each coin cell (2032) according to Example 2 and Comparative Example 1 for CV (2) evaluation, which are shown in Table 1, was manufactured in substantially the same manner as in the CV (1) evaluation except for using an electrolyte prepared by dissolving 1.3 M of LiPF₆ in a mixed solvent of ethylene carbonate/propylene carbonate/ethyl propionate in a volume ratio of 10/15/75 and the self-supporting film of the composite carbonaceous conductive material of Example 2 as a positive electrode.

### CV Measurements 1 and 2

Each cell of Examples 1 and 2 and Comparative Example 1 for the CV evaluations 1 and 2 was measured with respect to currents by injecting an oxidation-reduction potential within a range of 3.0 V to 5.0 V (vs. Li) at 5 millivolt per min (mV/min) by using a CV-measuring device, VMP-3Potentiostat made by BioLogic to compare the currents at 5 V. The results are shown in Table 1.

### Evaluation of Withstanding Voltage: Cyclic Voltammetry (CV) Measurement (3): Solid Electrolyte

### Manufacturing of Positive Electrode Pellets for Evaluation

Any one of the carbonaceous conductive materials of Example 3 and Comparative Example 1 was mixed with a sulfide solid electrolyte (Li₆PS₅Cl) in a solid weight ratio of 5:95 at 2000 rpm for 3 minutes with a dry mixer (FM3 mixer made by

Nippon Coke & Engineering Co., Ltd.) and then, made into a pellet with 10 mmϕ×0.1 mm (thickness) at a pressure of 15 MPa by using a powder-molding press (Lan press, Labonect Co., Ltd.), which was used as a positive electrode pellet for the CV (2) evaluation.

### Manufacturing of Separator Pellets for Evaluation

The sulfide solid electrolyte (Li₆PS₅Cl) was manufactured into a pellet with 10 mmϕ×0.5 mm (thickness) at a pressure of 15 MPa by using the powder-molding press to obtain a soluble solid electrolyte layer pellet for the CV evaluation.

### Manufacturing of CV (3) Cell for Evaluation

The positive electrode pellet for CV evaluation 2 and the solid electrolyte layer pellet were used with a metal lithium punched out into a size of 10 mmϕ as a counter electrode and then, sequentially placed in a solid battery cell case (KP-Solid Cell, Hohsen Corp.) and pressed at a pressure of 20 megapascal (MPa) to manufacture cells of Example 3 and Comparative Example 1 of for CV evaluation 3, which are shown in Table 1.

### CV Measurement 3

Each cell of Example 3 and Comparative Example 1 for the CV evaluation 3 was measured with respect to currents by injecting an oxidation-reduction potential within a range of 1.1 V to 6.0 V (vs. Li) at a scan rate of 5 mV/min by using the CV-measuring device, VMP-3 Potentiostat made by BioLogic to compare the currents at 6 V.

The results are shown in Table 1 for Examples 1, 2, 3, 4 and Comparative Examples 1 and 2 using the following column headings:
H1: Composite carbonaceous conductive material
H2: Boron amount (wt %)
H3: Nitrogen amount (wt %)
H4: Oxygen amount (wt %)
H5: B/N weight ratio
H6: Boron+nitrogen total amount (wt %)
H7: (B+N)/O weight ratio
H8: Coating layer thickness (nm)
H9, H10, H11: Withstanding voltage from CV evaluation 1, 2, 3, respectively, as an oxidation current density (mA/cm²)
H12: Sheet resistance as ohm per square (Ω/sq)

TABLE 1

| | H1 | H2 | H3 | H4 | H5 | H6 | H7 | H8 | H9 | H10 | H11 | H12 |
|---|---|---|---|---|---|---|---|---|---|---|---|---|
| Ex. 1 | A | 5.2 | 7.1 | 6.3 | 0.73 | 12.1 | 2.0 | — | 1.5 | — | — | 6.6 |
| Ex. 2 | B | 6.9 | 9.5 | 11.2 | 0.73 | 16.4 | 1.5 | 4 | 1.2 | 1.5 | — | 12.2 |
| Ex. 3 | C | 10.3 | 13.1 | 12.8 | 0.79 | 23.6 | 1.8 | — | — | — | 100 | 30.7 |
| Ex. 4 | D | 19.0 | 24.0 | 7.0 | 0.79 | 43.0 | 6.1 | — | — | — | — | 127.4 |
| Comp. | Non- | — | — | 3.4 | — | — | 0.0 | 0 | 2.0 | 1.7 | 225 | 4.1 |
| Ex. 1 | coated | | | | | | | | | | | |
| | MWCNT | | | | | | | | | | | |
| Comp. | E | 24.0 | 31.0 | 11 | 0.77 | 55.0 | 5.0 | — | — | — | — | 554.5 |
| Ex. 2 | | | | | | | | | | | | |

### Consideration of Examples and Comparative Examples

Referring to the results of Table 1, in Examples 1 to 3, compared with Comparative Example 1 containing no boron nitride, oxidation currents were suppressed or reduced in both of the CV evaluations 1 and 2 using the liquid-based/non-aqueous-based electrolytes and in the CV evaluation 3 using the solid electrolyte.

In some embodiments, the oxidation current density for the non-aqueous electrolyte rechargeable batteries was about 1 milliampere per square centimeter (mA/cm²) to about 1.5 mA/cm², or about 1.2 mA/cm² to about 1.5 mA/cm².

In some embodiments, the sheet resistance (e.g., surface resistivity) for the non-aqueous electrolyte rechargeable batteries was about 5 ohm per square (Ω/sq) to about 130 Ω/sq, about 5 Ω/sq to about 32 Ω/sq, about 5 Ω/sq to about 15 Ω/sq, or about 5 Ω/sq to about 7 Ω/sq.

This effect may be due to the formation of the coating layer containing the very electrochemically stable boron nitride material on the surface of carbon nanotubes.

In contrast, Comparative Example 2 using a composite carbonaceous conductive material containing greater than 21 wt % of boron element exhibited greater than or equal to 100 times higher sheet resistance than Comparative Example 1, resulting in being unusable as a conductive material.

As a result of the preceding observations, embodiments of the present disclosure were confirmed to suppress or reduce a side reaction between a carbonaceous conductive material and an electrolyte by forming a coating layer having a set or predetermined amount of boron element and nitrogen element on the carbonaceous conductive material and maintain conductivity of the conductive material.

For example, the preparation of composite carbonaceous conductive materials involves dispersing boric acid in ethanol, adding multiwall carbon nanotubes (MWCNTs), and drying the mixture to support the MWCNTs with boric acid. The supported MWCNTs are then heated to form boron oxide, followed by nitridization at high temperatures to coat them with boron nitride, resulting in a composite carbonaceous conductive material. Variations in the process include changing the amount of MWCNTs or using different solvents and drying methods to create films or other forms of the material.

The composite materials were evaluated through elemental analysis, confirming the presence of boron, nitrogen, and oxygen in the coating layer. The thickness of the coating layer was measured using transmission electron microscopy (TEM) and electron energy loss spectroscopy (EELS). The sheet resistance and withstanding voltage of the materials were tested, showing that the boron nitride coating effectively suppressed oxidation currents and maintained conductivity, even under high-voltage conditions.

Comparative examples without the boron nitride coating or with excessive boron content exhibited higher sheet resistance and poorer performance. The results demonstrated that the embodied composite carbonaceous conductive materials could significantly reduce side reactions and improve the stability and performance of rechargeable batteries.

A battery manufacturing device, a battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Descriptions of features or aspects within each embodiment should typically be considered as available for other similar features or aspects in other embodiments

While the present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims, and equivalents thereof.

What is claimed is:

1. A conductive material, comprising
a carbon nanotube, and
a coating layer on a surface of the carbon nanotube,
wherein the coating layer comprises a nitrogen element (N), a boron element (B), and an oxygen element (O),
a weight ratio (B/N ratio) of an amount of the boron element (B) to an amount of the nitrogen element (N) is greater than or equal to about 0.7 and less than or equal to about 1.3, and
the amount of boron element (B) is greater than or equal to about 1.0 wt % and less than or equal to about 21 wt % based on a total of 100 wt % of the conductive material,
wherein the conductive material is a composite carbonaceous conductive material.

2. The conductive material as claimed in claim 1, wherein
a total amount of the nitrogen element (N) and the boron element (B) is greater than or equal to about 2.0 wt % and less than or equal to about 50.0 wt % based on the total 100 wt % of the conductive material.

3. The conductive material as claimed in claim 1, wherein
the coating layer comprises boron nitride.

4. The conductive material as claimed in claim 1, wherein
the amount of the boron element (B) is greater than or equal to about 2 wt % and less than or equal to about 15 wt % based on the total 100 wt % of the conductive material.

5. The conductive material as claimed in claim 1, wherein
the amount of the boron element (B) is greater than about 3.6 wt % and less than or equal to about 10 wt % based on the total 100 wt % of the conductive material.

6. The conductive material as claimed in claim 1, wherein
a weight ratio ((B+N)/O ratio) of a sum of the amount of the boron element (B) and the amount of the nitrogen element (N) to the amount of the oxygen element (O) is greater than or equal to about 0.5 and less than or equal to about 8.0.

7. The conductive material as claimed in claim 1, wherein
a thickness of the coating layer is greater than or equal to about 0.3 nanometer (nm) and less than or equal to about 20 nm.

8. A positive electrode comprising:
a positive electrode active material; and
a conductive material,
wherein the conductive material is the conductive material as claimed in clam 1, and
wherein the positive electrode is a positive electrode for a rechargeable battery.

9. The positive electrode as claimed in claim 8, wherein
the positive electrode further comprises a sulfide solid electrolyte.

10. A rechargeable battery comprising:
a positive electrode;
a negative electrode;
a separator; and
a non-aqueous electrolyte,
wherein the positive electrode is the positive electrode as claimed in claim 8, and
wherein the rechargeable battery is a non-aqueous electrolyte rechargeable battery.

11. The rechargeable battery as claimed in claim 10, wherein
the rechargeable battery is charged and discharged at a voltage of greater than about 4.5 volt (V).

12. The rechargeable battery as claimed in claim 10, wherein
the rechargeable battery has an oxidation current density of about 1 milliampere per square centimeter (mA/cm²) to about 1.5 mA/cm².

13. The rechargeable battery as claimed in claim 10, wherein
the rechargeable battery has a sheet resistance of about 5 ohm per square (Ω/sq) to about 7 Ω/sq.

14. A solid rechargeable battery, comprising:
a positive electrode;
a negative electrode; and
a solid electrolyte layer,
wherein the positive electrode is the positive electrode as claimed in claim 8.

15. The solid rechargeable battery as claimed in claim 14, wherein
the solid electrolyte layer comprises a sulfide solid electrolyte.

16. The solid rechargeable battery as claimed in claim 14, wherein
the solid rechargeable battery is charged and discharged at a voltage of greater than about 4.5 V.

17. A method comprising:
providing a precursor layer comprising boron oxide and a carbon nanotube, the boron oxide covering at least a portion of the surface of the carbon nanotube; and
nitridizing the boron oxide to form a coating layer on the carbon nanotube, the coating layer comprising boron element (B) and nitrogen element (N),
wherein a weight ratio (B/N ratio) of an amount of the boron element (B) to an amount of the nitrogen element (N) is greater than or equal to about 0.7 and less than or equal to about 1.3, the amount of the boron element (B) is greater than or equal to about 1.0 wt % and less than or equal to about 21 wt % based on a total 100 wt % of a composite carbonaceous conductive material, and
wherein the method is a method of preparing the composite carbonaceous conductive material.

18. The method as claimed in claim 17, wherein
the providing the precursor layer comprises:
dipping at least a surface of the carbon nanotube in a solution comprising the boron element (B); or
coating the solution comprising the boron element (B) on at least one of the surface of the carbon nanotube.

19. The method as claimed in claim 17, wherein
the coating layer comprises boron nitride.

20. The method as claimed in claim 17, wherein
a thickness of the coating layer is greater than or equal to about 0.3 nm and less than or equal to about 20 nm.
